(19) United States
(12) Patent Application Publication
(10) Pub. No.: US 2011/0137596 A1
(43) Pub. Date: Jun. 9, 2011

(54) QUALITY CONTROL METHOD AND MICRO/NANO-CHANNELED DEVICES

(75) Inventors: Alessandro Grattoni, Houston, TX (US); Mauro Ferrari, Houston, TX (US); Xeuwu Liu, Westerville, OH (US)

(73) Assignee: The Board of Regents of The University of Texas System, Austin, TX (US)

(21) Appl. No.: 12/990,411

(22) PCT Filed: Apr. 28, 2009
(86) PCT No.: PCT/US2009/041957

§ 371 Date: Feb. 22, 2011

Related U.S. Application Data
(60) Provisional application No. 61/049,287, filed on Apr. 30, 2008.

(51) Int. Cl. G06F 19/00

(52) U.S. Cl. 702/84

(57) ABSTRACT

Embodiments of the present invention comprise a quality control system and method for testing micro- or nano-channeled devices. The system and method can utilize a pressure-driven gas flow for the detection and quantification of structural defects. The test method and system are non-destructive and allow defects to be detected and classified quickly based on measured factors, such as mass flow rate for a given pressure differential.

### CROSS-REFERENCE TO RELATED APPLICATIONS

This application claims the priority of U.S. Provisional Patent Application Ser. No. 61/049,287, filed Apr. 30, 2008, entitled “Quality Control Method for Micro/Nano-Channeled Devices”, the entire disclosure of which is specifically incorporated herein by reference.

This invention was made with government support under Grant No. NNJO6HE06A awarded by NASA and State of Texas ETF funding.

### BACKGROUND OF THE INVENTION

I. Field of the Invention

The present invention relates generally to the fields of a quality control system and method for testing micro- or nano-channeled devices. More particularly, it concerns use of a pressure-driven gas flow for the detection and quantification of device quality affected by structural defects or other manufacturing non-idealities.

II. Description of Related Art

Over the last three decades significant advances in silicon based technologies have been made. A large number of silicon fabricated devices are commercially available and widely used in the energy industry, food industry as well as in medical applications. Lab on a chip, micro/nano-fluidic devices, nano-channels membranes and filters can potentially be applied in clinical diagnostics, immunoassay, DNA and protein separation and analysis, cell culture and drug delivery. All these applications reflect the advantage of processing small volumes of fluids in small and compact structures. Silicon fabrication techniques allow producing large numbers of nominally identical devices with high reproducibility.

However, in applications such as drug delivery from implantable devices and high selectivity filtering, the silicon devices structure must have superior precision. In particular, the nano-channel size and number in implantable drug delivery membranes strongly determines the drug release from an implanted reservoir. It is easy to understand that an unintended size for a nano-channel and/or an erroneous number of properly functioning nano-channels in a device may translate into ineffective medical treatment or extremely dangerous overdosing.

The large scale production of such devices requires quality control methods to assure the superior quality of the final products and their conformity to a specific standard.

Although optical and electron microscopy are extremely useful techniques for the analysis of the structure of such devices, they present several limitation to their applicability in quality control of micro/nano-channeled devices. On one side, if electron-microscopy can provide high resolution images of small spots of the devices structure, its application to the analysis of large surfaces becomes prohibitive due to a very slow scanning process, high operating cost of the instrument, and large computational power required for the image storage and processing. On the other side, optical microscopy can more easily analyze bigger surfaces, but it cannot resolve nano-sized features. Moreover, microscopy techniques may be not able to operate on the final products due to the fact that there is no viewable access to the internal structure of the device.

Rejection testing, instead, is another technique commonly used to estimate the pore size in nano-channels filters. However, this method only provides a rough measurement of the maximum channel size and does not detect any membrane occlusion. Moreover the test is destructive and difficult to operate.

Therefore, there remains a need for a fast and accurate non-destructive quality control system and method for micro/nano-channel devices.

### SUMMARY OF THE INVENTION

Thus, in accordance with certain aspects of the present invention, there is provided a quality control system for testing a micro- or nano-channeled fluidic device, the quality control system comprising: a housing configured to hold a micro- or nano-channeled fluidic device, wherein the housing comprises an inlet and an outlet and wherein the micro- or nano-channeled fluidic device comprises an intentional gas permeable barrier; a gas reservoir coupled to the inlet of the housing, wherein the gas reservoir is configured to apply a gas pressure differential between the inlet and outlet of said housing; a pressure sensor configured to measure a gas pressure between the inlet and the outlet of the housing; and a gas control system configured to control the gas pressure between the inlet and the outlet of the housing.

Particularly, the micro- or nano-channeled fluidic device may be a nano-channeled drug-delivery device. In certain embodiments, the housing may comprise a clamping mechanism, seals and a lid, wherein the housing is configured to allow gas flow only through the micro- or nano-channeled fluidic device. In a particular embodiment, the clamping mechanism further comprises an electromagnetic clamping system, which may comprise a magnetic support and a magnet. For example, the gas control system may comprise a pressure regulator, or further comprises a tubing system. The gas sensor may be any pressure measuring devices, such as comprising a pressure transducer, which may be further coupled to an electronic measuring device, e.g., a multimeter.

The invention is also directed in certain embodiments to a quality control method for testing a micro- or nano-channeled fluidic device, comprising: applying a pressure differential across a micro- or nano-channeled fluidic device; measuring a pressure of gas upstream of the micro- or nano-channeled fluidic device; and determining a quality of said micro- or nano-channeled fluidic device by comparing said pressure with a standard curve. In certain embodiments, the method may be used during production or after production of the micro- or nano-channeled fluidic device. In specific embodiments, the method will find applicability in testing a single micro- or nano-channeled fluidic device or a plurality of micro- or nano-channeled fluidic devices at the same time. It is also contemplated that the method could be automated, such automation covering insertion and removal of one or a plurality of devices; control of the movement, pressure, and mixture of test gases; collection, processing, and display of test information; and interfacing with a factory control system.

In particular embodiments, the gas may be an inert gas, such as nitrogen. One or a plurality of gases may be applied in the disclosed system. The pressure sensor may generate an output signal transmitted to a reporting device, such as a computer. A plurality of gases and/or vapors may be applied in sequence and the results compared with a matching set of standard curves to refine the determination of device quality.

In certain embodiments, the pressure is measured in less than 60 seconds, about 100 seconds, about 200 seconds, about 300 seconds, about 400 seconds, about 500 seconds, about 600 seconds, about 700 seconds, about 800 seconds or any time in between the foregoing. Particularly, the pressure is measured by a gas pressure sensor at an inlet of the micro- or nano-channeled device, such pressure referenced to atmospheric pressure. In a further embodiment, the pressure differential is applied by a gas reservoir coupled only to an inlet of the micro- or nano-channeled device, the outlet being open to atmosphere.

The term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

The following drawings form part of the present specification and are included to further demonstrate certain aspects of the present invention. The drawings do not limit the scope but simply offer examples. The invention may be better understood by reference to one or more of these drawings in combination with the description of the illustrative embodiments presented herein:

FIGS. 1A-1D are schematics and images of an nDS membrane: FIG. 1A—three dimensional representation of the membrane; FIG. 1B—inner structure of the membrane; FIG. 1C—scanning electron microscope (SEM) image of the micro-channeled inlet; FIG. 1D—atomic force microscopy (AFM) image of the membrane structure.

FIG. 2 is a schematic of a quality control system according to an exemplary embodiment.

FIG. 3 is a schematic of a quality control system according to another exemplary embodiment.

FIGS. 4A-4B are pictures of a housing to hold an nDS membrane according to an exemplary embodiment.

FIG. 5 is a schematic of a theoretical model of an nDS membrane.

FIG. 6 shows the comparison between membranes affected by defects and the conformity region.

FIG. 7 shows an example of a dependence of the mass flow rate on the inlet-outlet pressure difference.

FIGS. 8A-8B illustrate 50th percentile (dotted line), mean (dash-dotted line) and the 25th and 75th percentiles (solid lines) of the mass flow rate data over ΔP=Pᵢₙ−Pₒᵤₜ for all membranes configurations (FIG. 8A-configurations 50×30, 48×20, 42×2; FIG. 8B—configurations 115×2, 42×2, 29×2, where the first number represents the depth of the nanochannels (in nm) and the second number represents the depth of the microchannels (in μm) (the key to each line on the right is in the same order from above to below as the line in the figure).

FIG. 9 depicts a mass flow rate dependence on the nano-channels height.

FIGS. 10A-10D illustrate characteristic curves obtained by pressure tests on 50×30 membranes presenting pinholes (A), regular structure (B) and unfinished patterns (C) (the key to each line on the right is in the same order from above to below as the line in the figure). The curves represent the experimental mass flow rate over the pressure drop (P) compared with the 50th, 25th and 75th percentiles. The image (D) shows section size variations. The size of each defect is expressed as number of involved micro-channels.

### DESCRIPTION OF ILLUSTRATIVE EMBODIMENTS

The invention and the various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

A superior quality of micro- nano-channeled devices is required in a variety of applications including bio-molecular separation and drug delivery. Although several techniques provide extremely useful characterization of specific properties of the micro-structured devices, their application to large scale quality control is prohibitive.

In the present invention, a novel, quick and non-destructive quality control system was developed which may comprise using convective nitrogen flow to detect even minor defects in the device structure. In particular, the sensitivity and reliability of the quality selection method was proven through an extensive experimental analysis performed on a complex-structured nano-channeled delivery system (nDS). Moreover, a mathematical model of nitrogen flow across the nDS was developed and its predictions were compared with the experimental results using the developed system and method by way of examples. The agreement between the theoretical and experimental data further validated the presented methodology.

In summary, the developed quality control system and method which overcome the limits of the traditional characterization techniques may be used in the large scale production of micro-/nano-fluidic devices assuring superior quality of products and their conformity to specific standards.

### I. NANO-CHANNEL DELIVERY SYSTEM

The micro- or nano-channeled device as used in exemplary embodiments of this invention refers to a fluidic device comprising a collection of arrays of a plurality of channels which are, in their smallest dimensions, 2 nm, 5 nm, 10 nm, 20 nm, 30 nm, 40 nm, 50 nm, 100 nm, 500 nm, 1 m, 5 m, or any intermediate number of the foregoing. The channels, e.g., rectangular or U-shaped channels, may be fabricated from materials such as silicon and silicon oxides, polymers, or metals, such as titanium. The device often has the form of a membrane or filter (i.e., a small piece of otherwise impermeable material made permeable by very small (nanometer-micrometer sized) channels fabricated through the body of the piece). An attribute of the quality control test method and the devices under test is that the permeability of the devices is created by intentional, precision engineering channels that should have well-characterized pressure responses. This is in contrast to other types of filters/membranes and related testers that are random arrangements of pores within fibrous or granular composites, paper, polymers, or other materials. Because of this, the test method has the potential to identify specific fabrication attributes, including proper and improper structures, which have model-able responses to the gas flow.

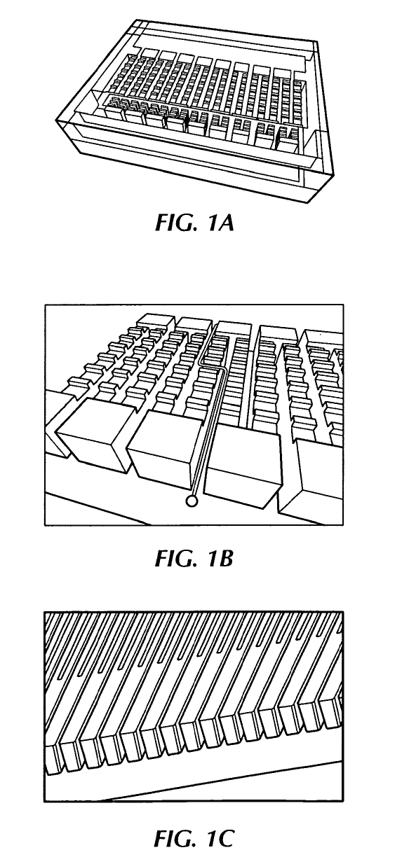

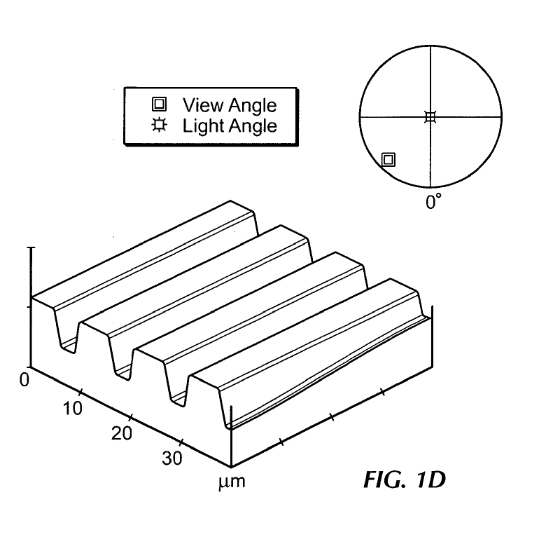

Referring to FIGS. 1A-1D, there is shown a specific example of a nano-channel delivery system (nDS) constructed in accordance with embodiments of the present invention, a bulk micro-fabricated nano-channel membrane. The nDS may comprise a micro-machined silicon structural layer and a Pyrex glass cap. The silicon layer houses a mesh of micro and nano-channels whose top surfaces are obtained by anodically bonding the glass layer to a grid of anchor points. The silicon wafer presents an interdigitated finger geometry composed of parallel micro-channels connected to each other by a set of perpendicular nano-channels (Schematics of the membrane structure are shown in FIGS. 1A and 1B). Fluids enter the membrane inlet, flow horizontally into a set of micro-channels, turn into the mesh of nano-channels and finally reach the outlet through another set of micro-channels (FIG. 1B). The nanometric dimension of the nano-channels may be the height, obtained by using a sacrificial oxide technique as in Example 1.

### II. QUALITY CONTROL SYSTEM

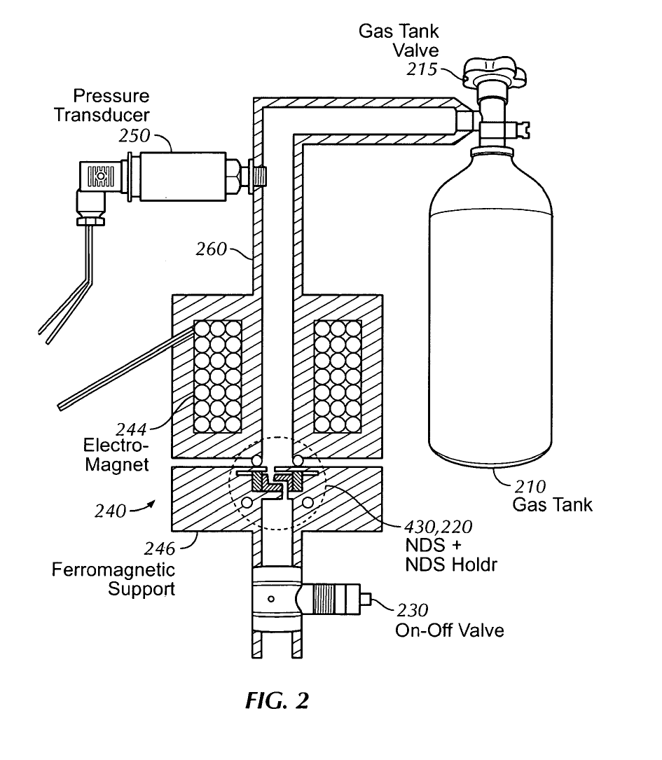

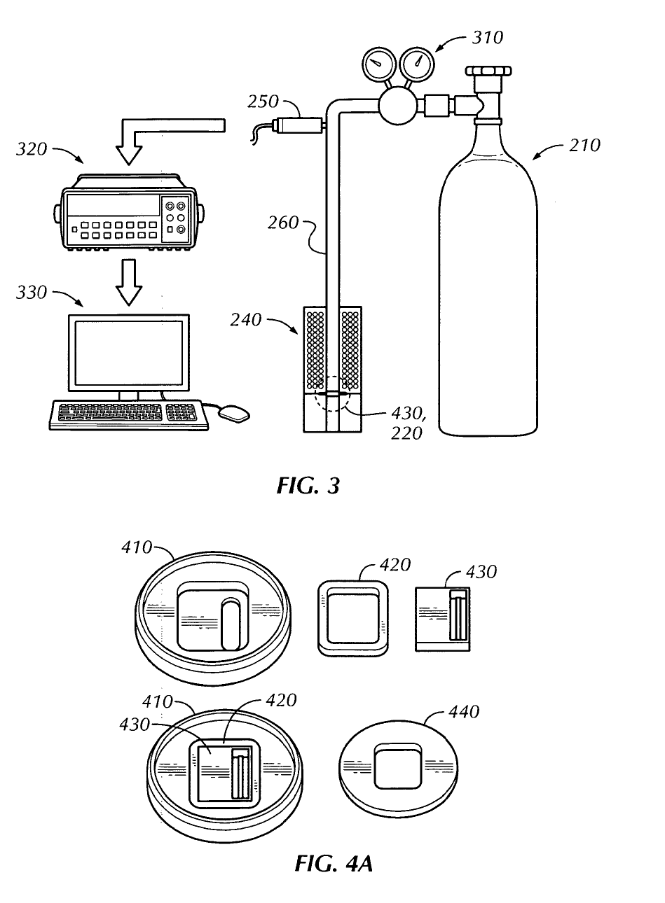

Referring to FIG. 2 and FIG. 3, there are shown two specific examples of a quality control system designed in accordance with embodiments of the present invention, which can be used for quality testing of a micro- or nano-channeled device 430 (for example, a drug delivery implantable device). The system may comprise a gas reservoir 210 (e.g., a gas tank such as a high purity nitrogen tank (Research Purity Grade 99.9999%, Matheson Tri-Gas®), a housing 220 (e.g., an nDS (nano-channeled delivery system) holder), a clamping system 240 (which may comprise an electromagnetic clamping system, a pressure sensor which may comprise a pressure transducer 250 (e.g., Full Scale 60 psi, accuracy 1%, K1, Ashcroft®, Inc.) and an electronic measuring device 320 such as a multimeter), and a gas control system which may comprise a tubing system 260 and may further comprise a flow regulator or assembly that limits the rate or amount of gas flowing there through to a target or a predetermined value, such as a gas-tank valve 215, an on-off valve 230 or a pressure regulator 310 (e.g., 3120-580, Matheson Tri-Gas®). In other embodiments, a flowmeter may be used to measure flow rather than a pressure transducer to measure pressure.

The valves in the system may be, for example, poppet valves, butterfly valves, or any other type of controllable flow valves known in the art. For example, the valves may be controlled to allow any range of gas flow to pass from the gas reservoir 210 to the device 430, such as a gas-tank valve 215. The valves may be positioned to partially or completely restrict a gas flow or may allow the flow to pass unrestricted. The valves may be connected to the system by any conventional means known in the art.

In some embodiments, one or more pressure sensors may be disposed proximate to an inlet (and outlet if measuring pressure differential) of the housing 220. The pressure sensor may be a device to which the housing 220 is coupled and may be external to the housing 220. Alternatively, the pressure sensor may be internal to the housing 220. The pressure sensor may send pressure information to a reporting device (not shown), which may be further coupled or internal to a control system 330 which may comprise a computer or a computer system, or send information directly to the control system without the reporting device.

The gas control system may couple various components of the quality control system to allow, for example, a gas to pass from the gas reservoir 210 to the micro- or nano-channeled device 430. The tubing system 260 may be any type of tubing, piping, or hose known in the art. The tubing system 260 may be, for example, plastic, rubber, aluminum, copper, steel, or any other material capable of delivering a compressed gas in a controlled manner, and may be flexible or rigid. The length of tubing system 260 may be minimized to facilitate operation of the quality control system.

The gas reservoir 210 may include, for example, an air compressor or a gas storage device or any other device capable of delivering gas through the tubing system 260. In one exemplary embodiment of the present disclosure, the gas reservoir 210 may be a commercial gas tank of a type known in the art and may supply compressed air, or any other gas, particularly inert gas, or more particularly, nitrogen. In certain embodiments, the composition of the gas contained in gas reservoir 210 should be verified as equivalent to the composition of the gas used to generate standard test curves or other data based on standard devices. The gas reservoir 210 may deliver a gas in a pulsed flow, a uniform flow, or some combination thereof. An inert gas may be used in exemplary embodiments, but more generally, it is contemplated that any suitable gas may be used to positively pressurize the system as desired. An inert gas is any gas that is not reactive under normal circumstances, such as nitrogen, helium, argon and the like. In addition, one gas can be used or multiple gases can be used to generate different gas flow responses for testing a device.

Pressure sensors can comprise pressure transducers, pressure transmitters, pressure senders, pressure indicators and any pressure sensing devices known in the art. In one embodiment, the quality control system includes a single pressure sensor. However, in some embodiments, additional pressure sensors can be placed in any suitable position. A “pressure transducer” as used herein, e.g., element 250, refers to a transducer that converts pressure into an analog electrical signal. Although there are various types of pressure transducers, one particular example commonly used is a strain-gage base transducer. The conversion of pressure into an electrical signal is achieved by the physical deformation of strain gages which are bonded into the diaphragm of the pressure transducer and wired into a Wheatstone bridge configuration. Pressure applied to the pressure transducer produces a deflection of the diaphragm which introduces strain to the gages. The strain will produce an electrical resistance change proportional to the pressure.

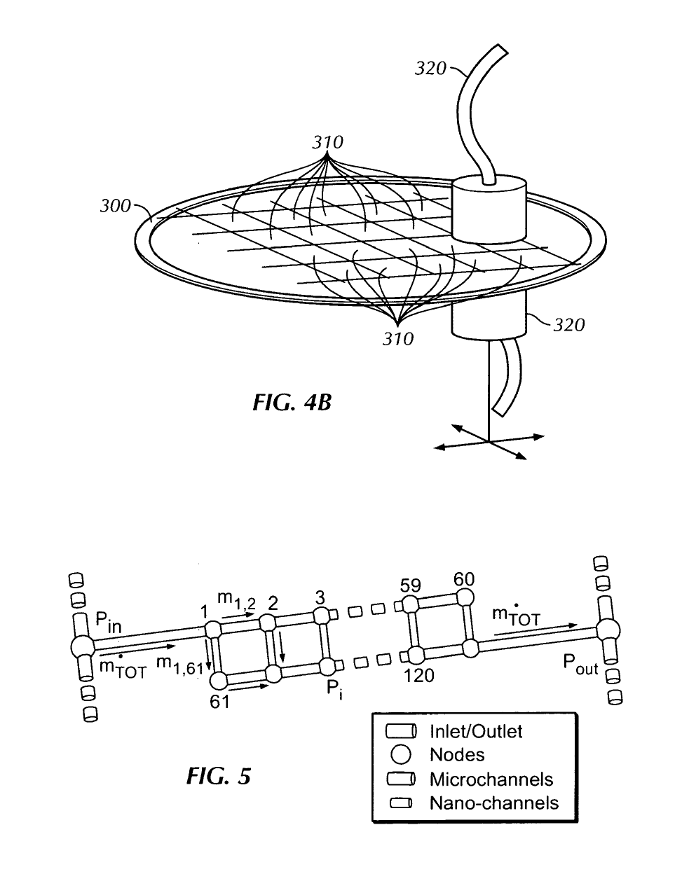

The housing 220 may be secured by any means known in the art, such as clamping, as will be described in greater detail below. Housing 220 may also comprise seals that may be made of plastic, rubber or any other material known in the art to prevent leak of gas. Referring to FIG. 2 and FIG. 4, a housing or more particularly, a nDS membrane holder 220, may be configured to house an nDS membrane 430 and a seal (e.g., a silicon rubber custom molded by Apple Rubber, Lancaster, N.Y., USA). While the embodiment shown allows for housing 220 to hold a single nDS membrane 430, certain embodiments may also be configured to allow membrane holder 220 to hold and test multiple nDS membranes 430 at the same time.

Housing 220 may also be a sub-assembly that resembles the actual product structure into which the nDS membrane 430 will be placed. For example, the nDS membrane 430 can be sealed within the sub-assembly, therefore an attachment method similar to that used between the sub-assembly and product may be used for attaching the sub-assembly to the quality control system.

Housing 220 may comprise a membrane seat 410 and a lid 440. The membrane seat 410 may be a disc-like structure or any shape desired to achieve the sealing effect. The membrane hermetical seal is assured by the tight dimensioning of membrane holder 220 and custom seal. Moreover, the lid 440 operates an additional sealing effect by compressing the silicon rubber against the side surfaces of the nDS membrane 430 and the inner faces of the membrane seat 410. The bottom side of the membrane holder 220 or 410 and the lid 440 present two openings as outlet and inlet facing the membrane outlet and inlet, respectively, allowing the gas flow during the tests.

Referring to FIG. 2 and FIG. 4, a clamping system may comprise an electromagnetic clamping system 240 comprising a ferromagnetic support 246 and an electromagnet 244. An axial passing through hole is hollowed in the ferrous base 246 in which also the membrane holder seat is machined. The electromagnet 244 comprises an axial duct which is coupled to the gas tubing system 260. The membrane holder 220 is clamped against the ferrous base 246 through the electromagnet 244. The hermetic seal is provided by two O-rings pressed against the membrane holder 220 and its lid 440. The electromagnet 244 is configured to assure the needed clamping force during the gas testing under pressure. The tubing system 260 coupling to the gas tank 210 to the electromagnet 244 serves as pressurized gas reservoir during the test.

Certain alternate embodiments may also comprise systems configured to test micro- or nano-channeled devices during the manufacturing process. For example, in specific embodiments, the micro- or nano-channeled devices may be fabricated using silicon wafer manufacturing techniques. Existing systems (sometimes referred to in the art as “wafer probe stations”) can hold an entire wafer and scan a probe system across the wafer to each die on the wafer. In certain embodiments of the present disclosure, such systems (or other systems structured to engage a wafer and move across the face of the wafer) can be configured with user-defined wafer interfaces (including gas-tight seals). These interfaces can engage each potential micro or nano-channeled device in order to perform the desired pressure or flow measurements before the wafer was diced into micro or nano-channeled devices. A perspective view of such an embodiment is illustrated in FIG. 4B. In the embodiment shown, a wafer 300 comprises many dice, each of which is a potential micro or nano-channeled device 310. A quality control system 320 can engage a single potential micro or nano-channeled device 310 (or a subgroup of wafer 300 consisting of a group of micro or nano-channeled devices 310). Quality control system 320 can perform pressure (or flow) tests similar to those described above, and the test data can be compared to reference data to determine if any of the potential micro or nano-channeled devices 310 are defective. By detecting potential defects earlier in the manufacturing process, it may be possible to reduce overall manufacturing costs by eliminating manufacturing steps for potential micro or nano-channeled devices 310 that are defective. In certain embodiments, quality control system 320 can be combined with a quality control system similar to that described in FIG. 2 or 3, which is configured to test the micro or nano-channeled devices after they have been cut or diced from wafer 300.

Certain embodiments may also be directed to a quality control method comprising using the quality control system set forth above. For example, certain embodiments may comprise applying a pressure differential across a micro- or nano-channeled fluidic device; measuring a pressure of gas upstream of the device; and determining a quality of the device by comparing the pressure with a standard curve. For example, the method may comprise installing the device into a housing, sealing the housing by applying a clamping system, and utilizing a gas control system to apply a pressure across the device. Embodiments may also comprise measuring a pressure response by gas pressure sensor from the inlet or upstream of the device and comparing the pressure response with a standard. Certain embodiments of the method were validated in the Examples section by comparing the pressure responses of certain devices with theoretical predictions based on the defined characteristics of the devices, which are described below.

In specific embodiments, the method may comprise using different gases with different molecular structures (including, for example, different molecular sizes for each of the gases). By testing the nDS membrane with different gases having different molecular structures, it may be possible to obtain additional useful data by reviewing the pressure curves generated with each gas. For example, it may be possible that a structural discrepancy in an nDS provides a more noticeable response with a test gas having a certain molecular size or structure. By utilizing multiple test gasses, it may be possible to detect structural discrepancies that may not be detected with test results from just a single gas. In particular, the suitability of devices to mathematical modeling of gas flows therethrough enhances the practical application of measurement using gases with different properties.

Several gases can be employed for the purpose of the quality control testing. Theoretically, any gas which does not cause damage or unwanted modification to the device structure or physical-chemical properties of the channel surface may be used for this application. The fluidics across a device, at given inlet and outlet pressure conditions, are strongly related to the gas properties. At the micro-/nano-scale, the fluidics of gas are strongly influenced by interaction between gas molecules and the walls of the device, gas rarefaction and slip velocity at the walls (non-continuum effects). These effects reflect an anomalous behavior of gas flow when compared to their macroscopic fluidics. The Knudsen number is commonly adopted to quantify the non-continuum effects on the gas flow. The Knudsen number is strongly related to the mean free path of the gas molecules. In particular a gas presenting large mean free path (λ) is more easily affected by non-continuum effects than a gas presenting small λ. These effects are more and more emphasized by reducing the size scale of the system in which the flow takes place.

Gases presenting large λ (such as Helium) may give more information on nano-sized channels. In conclusion, the employment of different gas may give different emphasis to differently sized features of channeled devices. In common practice noble gases such as nitrogen, helium and argon are largely used in numerous applications for their properties: they are inert, generally not dangerous and easy to be handled. Other gases such as propane, methane may be used as well but they present several difficulties related to their hazardous properties.

### III. THEORETICAL MODEL

A mathematical model of the gas flow across the devices was developed by the inventors taking into account the design, the physical-chemical properties of the surface and the size and shape of the channels. In Example 3 the mass flow rate predictions were compared to the experimental data to confirm the validity of the methodology comprised in embodiments of the present invention.

The nDS (nano-channeled delivery system) membrane was represented as a parallel network of 136 branches which were composed of an inlet micro-channel connected to an outlet micro-channel by 60 parallel nano-channels. A schematic of the model is shown in FIG. 5.

Generally, at the micro-scale the continuum hypotheses for gas flow are no longer valid. In micro-channels rarefaction effect, velocity slip at boundaries and gas-wall interactions become significant. The Knudsen number (Kn), defined as the ratio between the mean free path (λ) of a gas to the characteristic length scale of the flow (D), is used to quantify the non-continuum effects. For λ<<D (Kn<10−3) the continuum hypotheses are valid, for 10−3<Kn<10−1 the flow is described by the slip-regime, while for comparable or larger than D (Kn>10−1) transition and free molecular regimes are considered.

Kn is also related to the Reynolds (Re) and Mach (M) numbers as follows:

$$Kn ≡ \frac{λ}{D} = \sqrt{\frac{γπ}{2}} \frac{M}{Re} = \sqrt{\frac{π}{2 {R}_{s} T}} \frac{μ}{ρ D} \qquad ( 3 )$$

where is the specific heat ratio, μ is the gas viscosity, Rs is the specific gas constant, T is the absolute temperature, ρ is the gas density and D is the characteristic dimension of the system. In embodiments of the present invention the local Kn varied in the ranges of 0.0065-0.025 and 0.082-1.63 in the micro-channels and nano-channels, respectively. The nitrogen flow in the rectangular micro-channels was assumed to be compressible, steady-state, two dimensional and isothermal, with negligible transverse velocities. A fully developed flow was considered in each branch by neglecting the inertia effects. Following Arkilic et al. (2001), the first order slip-flow was considered. Each branch of the micro-channel between two consecutive nano-channels was represented by the flow equation

$${\dot{m}}_{i , i + 1} = \frac{{H}^{3} {WP}_{i + 1}^{2}}{24 μ {LR}_{s} T} [ {( \frac{{P}_{i}}{{P}_{i + 1}} )}^{2} - 1 + 12 ( \frac{2 - {σ}_{v}}{{σ}_{v}} ) {Kn}_{i + 1} ( \frac{{P}_{i}}{{P}_{i + 1}} - 1 ) ] \qquad ( 4 )$$

where \dot{m}_{i,i+1} is the mass flow rate, Pi and Pi+1 are the segment inlet and outlet pressures, respectively, Kni+1 is the outlet Knudsen number and W, H and L are the micro-channel width, height and length, respectively. The tangential momentum accommodation coefficient (TMAC, σv) represents the average streamwise momentum exchange between the flowing gas molecules and the surface of the walls. TMAC is a parameter that combines the gas and surface material properties with the wall roughness. The limit condition σv=0 represents no tangential momentum exchange between the gas and the walls. A diffuse reflection (σv=1) occurs when the molecules are reflected with zero average tangential velocity, a proper model for rough surfaces. In the present invention the micro-channels may be composed of silicon (bottom surface and sidewall roughness approximately equal to 6 nm and 30 nm, respectively) and of Pyrex 7740 glass (2.0 nm average roughness). According to Jang and Wereley (2006), a σv value equal to 0.98 was used, which considered the surface roughness and chemistry of both materials.

The Kn values obtained for the nano-channels indicates that the flow can be considered in between the transition and Knudsen regime. Two different approaches were considered and compared: 1—the same hypotheses and assumptions were applied to the nano-channel's flow as developed for the micro-channels (model 1), 2—a steady-state diffusive transport regime with a constant diffusion coefficient and negligible viscous effects was considered (Roy et al., 2003) (model 2).

In the first case, a first order slip flow was adopted by neglecting the entrance effects and considering a fully developed flow, described by equation (4). The average relative roughness of the silicon surface was measured as 2% of the channel depth thus, according to literature (Arkilic et al., 2001), a value of σv=0.75 was chosen for the nano-channels. A TMAC value equal to 0.98 was instead used for the nDS configuration 48×20.

In the second case, the mass flow rate in each nano-channel was expressed by

$${\dot{m}}_{i , i + 60} = {D}_{K} \frac{A ( {P}_{i} - {P}_{0} )}{MW \cdot R T L} \qquad ( 5 )$$

where A is the channel cross section area, MW is the gas molecular weight and R is the ideal gas constant. The Knudsen diffusivity Dk was given by

$${D}_{K} = \frac{{D}_{h}}{3} \sqrt{\frac{8 R T}{π MW}} \qquad ( 6 )$$

where Dh is the hydraulic diameter of the channel.

By imposing the upstream and downstream pressures (Pin, Pout), the pressures at each node (Pi) and the mass flow rate in each branch (\dot{m}_{i,i+1}) were numerically determined. The solution was declared convergent when the maximum residual for the variables became smaller than 10−9.

### IV. EXAMPLES

The following examples are included to further illustrate various aspects of embodiments of the invention. It should be appreciated by those of skill in the art that the techniques disclosed in the examples that follow represent techniques and/or compositions discovered by the inventor to function in the practice of embodiments of the invention. Those of skill in the art should, in light of the present disclosure, appreciate that many changes can be made in the specific embodiments which are disclosed and still obtain a like or similar result without departing from the spirit and scope of the invention.

### Example 1

### Manufacturing of nDS Membranes

The micromachining protocol of nDS (nano-channeled delivery system) is known to ordinary persons skilled in the art, such as described in U.S. Patent Publication No. 2007/0066138, herein incorporated by reference. Table 1 shows the specifications of exemplary nDS devices (nano-channel heights (nCh H) AFM measurements, micro-channel height (Ch H), channel number (N), cross-section width (W), length (L) and shape (CS)).

TABLE 1
Features size of the 5 nDS configurations

| | nCh H | μCh | μCh |
|---|---|---|---|
| nDS | [nm] | H [μm] | CS |
| 29x2 | 29 ± 2 | 2 | [symbol] |
| 42x2 | 42 ± 3 | 2 | [symbol] |
| 115x2 | 115 ± 12 | 2 | [symbol] |
| 48x20 | 48 ± 3 | 20 | [symbol] |
| 50x30 | 50 ± 3 | 30 | [symbol] |
| | W | L | |
| | [μm] | [μm] | N |
| μChIN | 6 | 1400 | 137 |
| μChOUT | 6 | 1400 | 136 |
| nCH | 13 | 5 | 120* |

*number of nano-channels for each micro-channel.

### Example 2

### Performing of Quality Control Testing

In certain exemplary embodiments, a quality control test may be performed in the following procedures by a quality control system. Prior to testing, nDS membranes were observed by using an upright microscope (XJM213—MTI Corporation). The nDS membrane was housed in a housing and the housing was clamped in its holder seat of a clamp base. A gas tubing system comprised in the quality control system was filled with nitrogen by previously removing the air entrapped and coupled to a gas tank. After clamping the electromagnet, the quality control system was filled with nitrogen at a relative pressure of 0.31 MPa and a pressure regulator valve was operated in order to insulate the gas tank from the tubing system. The gas could only exit the gas control system by flowing through the nDS membrane. The pressure drop due to the gas flow throughout the nDS membrane was measured and the pressure transducer output data were collected with a digital multimeter (model 34410A, Agilent Technologies, Santa Clara, Calif., USA) at 0.1 Hz for 700 seconds.

Prior to performing an extensive experimental analysis, a series of tests were performed to ensure that no leakage affected the reliability of the system. First, the gas test was performed by replacing the membrane holder with a bulk metal disc. Second test was performed by using a membrane previously clogged with glue, to analyze the efficacy of the custom seal. In both cases no significant leakage was observed. The reproducibility of the system was also verified by repetitively (10 times) performing the gas testing with the same nDS device. A negligible deviation between the experimental data smaller than 0.08% was observed.

The collected pressure data were fitted with an exponential function p(t)=k·e^{-Dt} (always R2>0.99) and each curve was plotted in a time range of 660 s starting from a relative pressure of k=0.31 MPa. The cumulative amount of nitrogen flown over the time F(t) was calculated through the relation:

$$F ( t ) = \frac{{V}_{sys} MW}{R T} ( p ( {t}_{0} ) - p ( {t}_{i} ) ) \qquad ( 1 )$$

Where V_{sys} is the testing system volume, MW=28.02 g/mol is nitrogen molecular weight, R is the ideal gas constant, T is the temperature of the gas in the reservoir, p(t₀)=k is the starting pressure and p(tᵢ)=k·e^{-Dt}^{ᵢ} is the pressure at the ith instant. Finally, the mass flow rate \dot{m}(t) was calculated as the derivative of the cumulative amount over the time

$$\dot{m} ( t ) = \frac{d F ( t )}{d t} = \frac{{V}_{sys} MW}{R T} Dk \cdot {e}^{- Dt} \qquad ( 2 )$$

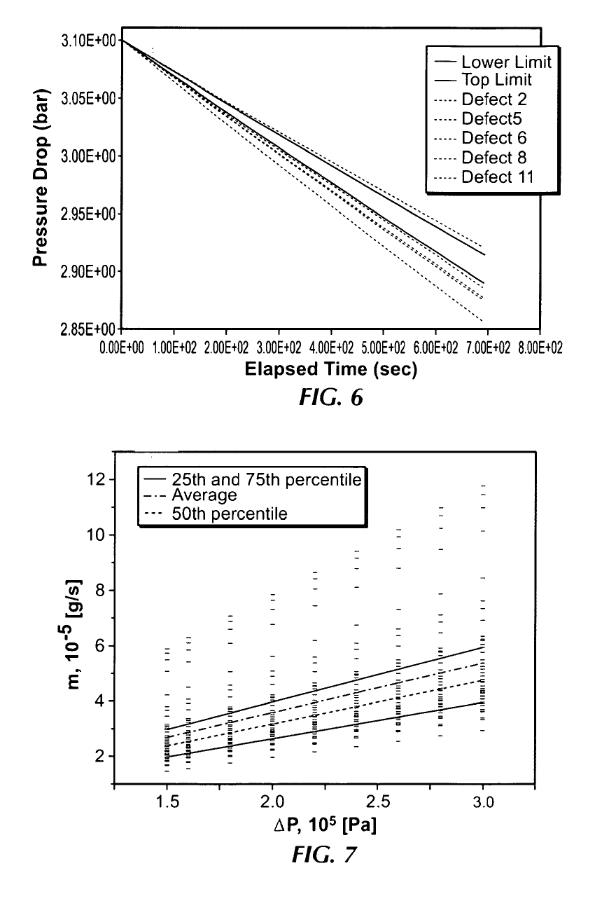

Standard membrane curves were chosen by a statistical analysis performed over 50 membranes, which were selected by 40× optical microscopy described in detail in Example 3. The selection can be performed on both pressure drop data and flow rate versus pressure drop data. By way of demonstration, FIG. 6 shows the comparison between membranes affected by defects and the conformity region (the area limited by the solid lines). The dashed lines are pressure drop curves related to membrane presenting defects.

### Example 3

### Validation of the Quality Control Method

Pressure test was performed on 50 membranes for each configuration manufactured according to Table 1. The statistical analysis was performed on the mass flow rate data obtained for each configuration. The 25th, 50th and 75th percentiles were calculated. The mean of the data related to each configuration was verified to be significantly different through one-way ANOVA test (Analysis of variance) performed at the 0.005 level.

A linear dependence of the mass flow rate on the inlet-outlet pressure difference (ΔP=Pᵢₙ−Pₒᵤₜ) was observed in the considered pressure range 0.3-0.15 MPa. The experimental results obtained by testing the 48×20 nDS are shown in FIG. 7 as an example.

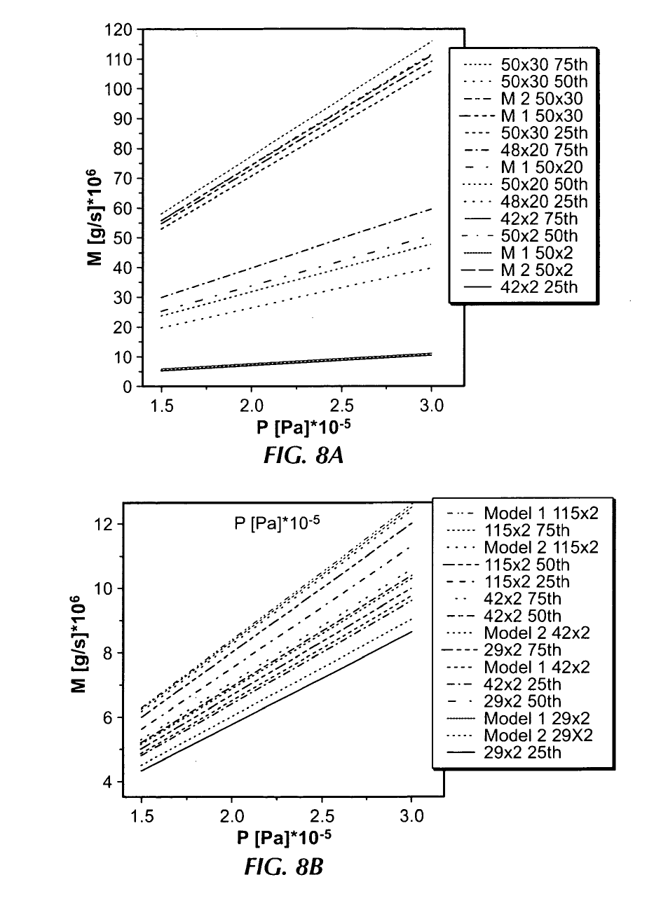

Generally, the experimental results do not show normal distribution. Errors encountered during the micro-fabrication process are easily reproduced on several devices; thus, the deviation of the device structure from its nominal design may not result in a normally distributed response. The 50th percentile (50th) was assumed as a representative curve for each configuration and the results ranging between the 25th and 75th percentile were considered safe in regards of the devices structure quality. The 50th, 25th and 75th percentiles with the mean for each membrane configuration are shown in FIGS. 8A-8B and the differences in their slopes are reported in Table 2. The difference between the mean and the 50th clearly highlights the deviation of each data set from a Gaussian distribution.

Table 2 Slopes of the mass flow rate on pressure drop for the 50th percentile and percentage deviations of 25th and 75th percentiles, the mean and the theoretical models predictions for each nDS configuration

| | SLOPE 50th, | DEV % | DEV % | DEV % | DEV % | DEV % |
|---|---|---|---|---|---|---|
| | 10-06 | 25th | 75th | mean | model 1 | model 2 |
| 29x2 | 3.24 | −11 | 6.8 | −1.9 | −7.3 | −1.5 |
| 42x2 | 3.45 | −3.5 | 2.3 | −0.01 | −0.56 | 0.31 |
| 115x2 | 4.00 | −5.8 | 4.2 | −1.9 | 4.5 | 3.2 |
| 48x20 | 15.85 | −17 | 25 | 14 | 5.9 | 68 |
| 50x30 | 37.13 | −5.1 | 3.8 | −0.62 | −1.9 | −0.22 |

Membranes with different configuration show a distinct characteristic behavior, except for 42×2 and 29×2 (as confirmed by one-way ANOVA test). The ranges between the 25th and 75th percentiles of these two configurations overlap.

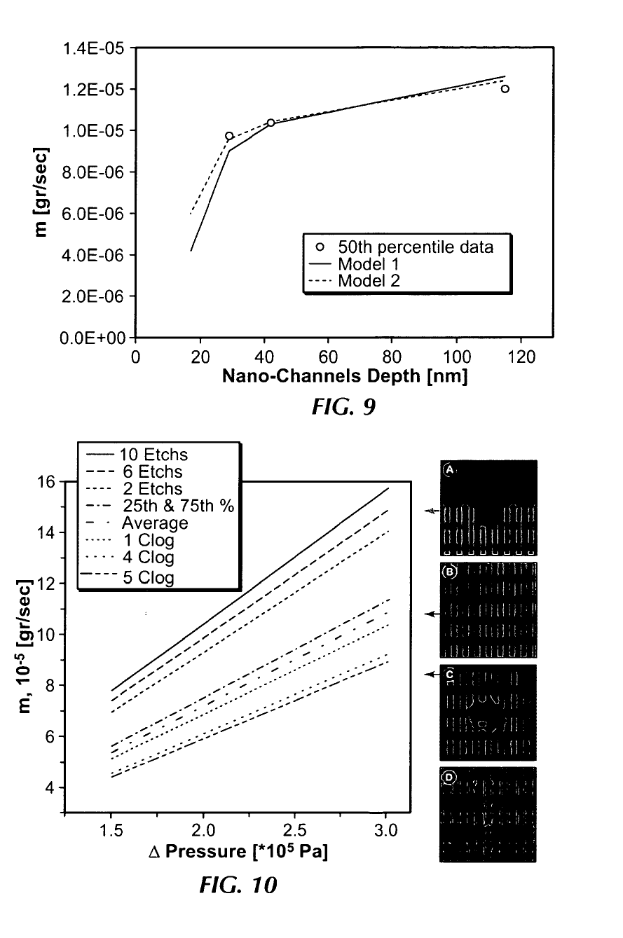

The data in FIGS. 8A-8B show that both micro-and nano-channels size influence the gas flow. FIG. 8A, in which the nDS configurations presenting nano-channel height of about 50 nm are compared, shows that the flow rate increases with micro-channel size. In FIG. 8B and FIG. 9 the configurations presenting 2 m high micro-channels are compared. In the range of 29 to 115 nm, the dependence of the flow rate on the nano-channel height slightly decreases with the increase in nano-channel size. These results reveal a “saturation” effect of the micro-channels, which, at increased nano-channels height, becomes the dominant feature on gas flow rate.

In FIGS. 8A-8B, the curves predicted by the mathematical models are also shown. The two predictions are generally close to each other, indicating that the gas flow in between the transition and free molecular regime can be described by both slip-flow (model 1) and Knudsen diffusion (model 2). The percentage of the models deviation from the 50th percentile is listed in Table 2. If generally both predictions fall in the ranges between the 25th and 75th percentiles, the model 2 better represents the 50th for most of the configurations, being its deviation smaller than 5%. In this regard the nDS configuration 48×20 represents an exception. For this device, the AFM measurements showed a significant roughness on the nano-channel silicon surface. Model 2 does not consider the effect of the roughness in the nano-channels, while model 1 takes it into account by mean of the TMAC. Hence, for the nano-channels of this configuration a TMAC equal to 0.98 was considered. On one side model 1 can take into account the roughness of the nano-channels and its results are strongly related to the TMAC value which can only be empirically determined. On the other side, the model 2 is not sensible to roughness variation, its prediction for smooth nano-channels is almost univocally determined. In fact, a variation of the micro-channels TMAC in the range 0.95-1 always leads to smaller prediction differences than 0.19%.

The micro and nano features of nDS rely on the photolithographic process. This technique allows high flexibility in micro- and nano-channel design and assures high reproducibility, but defects such as pinholes, unfinished patterns, section size variations, anomalous roughness of nano-channel surface and void anodic bonding may occur during the micro-fabrication process. Pinholes are unexpected etches of the device structure that may cause unwanted holes that link channels. They may occur when the protective masking layers presents some defects. Unfinished patterns are unetched areas that interrupt the channels. They are due to the presence of undesired particles on the wafer during the photolithography process. Section size variations can be caused by the deformation of the glass layer or non-uniform thickness of the photo-resist. Anomalous roughness of nano-channel surface may be caused by non-uniform protective layer or uneven layer removal.

Furthermore the proportion of the defects can be very different and it varies from sample to sample even among membranes of the same batch. In order to quantify the sensitivity of the gas system to defects, the quality control method was performed on some defective membranes. Even if the gas system herein proposed was distinctly sensitive to all the defects listed above, only pinholes and unfinished patterns could be detected and quantified through optical microscopy on undivided nDS, without removing the glass layer or sectioning the device. Thus, in order to determine the defects influence (size and nature) on the gas flow, the quality control method was performed on several nDSs presenting pinholes and unfinished patterns. The characteristic curves are shown in FIG. 10.

Compared to the range between the 25th and 75th percentiles, the nDS membranes presenting pinholes showed a significantly higher mass flow rate. On the opposite side, the presence of unfinished patterns caused a reduction of the measured flow rate. The mass flow rate variations due to pinholes and unfinished patterns were proportional to the extent of the damaged areas (number and length of the involved channels). However, pinholes induce a more significant flow rate deviation than blocked channels. The pinholes, indeed, allow the gas to directly flow from the inlet to the outlet micro-channels, bypassing the set of nano-channels. As a result, the smaller the nano-channels and the bigger the micro-channels, the bigger is the pinhole effect. The presence of blocked micro-channels, instead, reduces the number of nano-channels in which the gas can flow. When the block occurs in proximity of the outlet, the fluidics within the membrane is almost not affected. When the block occurs in proximity of the inlet, a significant number of nano-channels are involved and mass flow reduction becomes more relevant.

In general the results show that the developed quality control system is able to reveal even minor defects such as a single closed channel (as displayed in FIG. 10). The accuracy of the detection is related to the fluidics behavior of gases which are extremely sensible to size, shape, roughness and chemistry of channels.

All of the systems, devices and/or methods disclosed and claimed herein can be made and executed without undue experimentation in light of the present disclosure. While the systems, devices and methods of this invention have been described in terms of particular embodiments, it will be apparent to those of skill in the art that variations may be applied to the systems, devices and/or methods in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### V. REFERENCES

The following references, to the extent that they provide exemplary procedural or other details supplementary to those set forth herein, are specifically incorporated herein by reference:
Arkilic et al., Journal of Fluid Mechanics, 437, 29-43, 2001.
Jang and Wereley, Journal of Micromechanics and Microengineering, 16, 493-504, 2006
Roy et al., Journal of Applied Physics, 93, 4870-4879, 2003

1-24. (canceled)

25. A quality control system for testing a micro- or nano-channeled device, the quality control system comprising:
a housing configured to hold a micro- or nano-channeled device, wherein the housing comprises an inlet and an outlet and wherein the micro- or nano-channeled device comprises defined channels;
a gas reservoir coupled to the inlet or outlet of the housing, wherein the gas reservoir is configured to apply a gas pressure to the inlet or outlet of said housing;
a pressure sensor configured to measure a gas pressure at the inlet and/or outlet of the housing; and
a gas control system configured to control the gas pressure at the inlet or outlet of the housing.

26. The quality control system of claim 25, wherein said micro- or nano-channeled device is a nano-channeled drug-delivery device.

27. The quality control system of claim 25, wherein said housing comprises a clamping mechanism, seals and a lid, wherein said housing is configured to allow gas flow only through said micro- or nano-channeled device.

28. The quality control system of claim 27, wherein said clamping mechanism further comprises an electromagnetic clamping system.

29. The quality control system of claim 28, wherein said electromagnetic clamping system comprises a magnetic support and a magnet.

30. The quality control system of claim 27, wherein said clamping mechanism further comprises a mechanical clamping system that comprises at least a moving part to clamp the micro- or nano-channeled device.

31. The quality control system of claim 25, wherein said gas control system comprises a pressure regulator.

32. The quality control system of claim 25, wherein said pressure sensor comprises a pressure transducer.

33. A quality control system for testing a micro- or nano-channeled device, the quality control system comprising:
a housing configured to hold a micro- or nano-channeled device, wherein the housing comprises an inlet and an outlet and wherein the micro- or nano-channeled device comprises defined channels;
a gas reservoir coupled to the inlet or outlet of the housing, wherein the gas reservoir is configured to apply a gas pressure to the inlet or outlet of said housing;
a flow meter configured to measure a gas flow at the inlet and/or outlet of the housing; and
a gas control system configured to control the gas pressure or gas flow at the inlet or outlet of the housing.

34. The quality control system of claim 33 wherein said housing comprises a clamping mechanism, seals and a lid, wherein said housing is configured to allow gas flow only through said micro- or nano-channeled device.

35. The quality control system of claim 33, wherein said gas control system comprises a pressure regulator.

36. A quality control method for testing a micro- or nano-channeled device, comprising:
applying a pressure differential across a micro- or nano-channeled device;
measuring pressure changes over time of gas upstream and/or downstream of the micro- or nano-channeled device; and
determining a quality of said micro- or nano-channeled device by comparing said pressure changes over time with a standard curve.

37. The method of claim 36, wherein said method is performed during production of said micro- or nano-channeled device.

38. The method of claim 36, wherein said method is performed after production of said micro- or nano-channeled device.

39. The method of claim 36, wherein said gas comprises a plurality of gases.

40. The method of claim 36, further comprising:
applying a subsequent pressure differential across a micro- or nano-channeled device, wherein a different gas is used to apply the subsequent pressure differential;
measuring a pressure of the different gas upstream and/or downstream of the micro- or nano-channeled device; and
determining a quality of said micro- or nano-channeled device by comparing said pressure with a standard curve

41. The method of claim 36, wherein said pressure sensor generates an output signal transmitted to a reporting device.

42. The method of claim 36, wherein said measuring is performed in less than one minute.

43. The method of claim 36, wherein said pressure changes are measured by a gas pressure sensor at an inlet of said micro- or nano-channeled device.

44. The method of claim 36, wherein said pressure differential is applied by a gas reservoir coupled to an inlet of said micro- or nano-channeled device.
